(19) United States
(12) Patent Application Publication
(10) Pub. No.: US 2009/0230071 A1
(43) Pub. Date: Sep. 17, 2009

(54) Foldable Lifting Apparatus

(76) Inventor: Scott R. Thompson, Dickinson, ND (US)

Correspondence Address: REALTRONICS CORPORATION;SCOTT R. THOMPSON, P.O. BOX 906, DICKINSON, ND, 58639, US

(21) Appl. No.: 12/473,377

(22) Filed: May 28, 2009

Related U.S. Application Data
(63) Continuation of application No. 12/044,944, filed on Mar. 8, 2008.
(60) Provisional application No. 61/013,571, filed on Dec. 13, 2007.

(51) Int. Cl. B66C 23/18

(52) U.S. Cl. 212/292; 212/179

(57) ABSTRACT

Embodiments of a recoverably installable portable lift are disclosed. A novel feature of the present invention is the ability to retract to a stored position that does not interfere with other features or functions of the host apparatus. The disclosed invention further mitigates the need for disassembly between uses.

### CROSS REFERENCE TO RELATED APPLICATIONS

This application is a continuation of U.S. patent application Ser. No. 12/044,944, filed Mar. 8, 2008 and titled “Recoverably Installable Vehicle Lifting Hoist—Method and Apparatus”. This application claims the benefit of priority under 35 U.S.C. 120 to U.S. patent application Ser. No. 12/044,944, which claims the benefit of priority under 35 U.S.C. 119(e) to provisional application No. 61-013571 filed Dec. 13, 2007 and titled “Rear-Vehicle Lifting Hoist—Method and Apparatus”.

### STATEMENT REGARDING FEDERALLY SPONSORED RESEARCH

### None

### FIELD OF THE INVENTION

The present invention teaches a recoverably installable lifting apparatus that engages a receiver adapter.

### BACKGROUND OF THE INVENTION

Prior art abundantly teaches useful lifting devices that are permanently or semi-permanently installed into the floor, frame, roof, sides and other structurally sound areas of a hosting object. A growing number of hoists teach recoverably installable methods that engage a receiver adapter on a vehicle, table, shop bench, wall or other stable structure. However prior art continues to suffer drawbacks that limit market participation.

Within the class of recoverably installed lifting cranes that engage an insert adapter, prior art fails to teach a pivoting point that is hinge coupled to a low base structure to reduce the size of the apparatus when it is folded. A low hinge point is needed to enable a fully assembled unit to fold into a compact stowed state and further to mitigate the need for disassembly between uses.

Harr and Cary teach a low pivoting point cranes in U.S. Pat. Nos. 5,752,799 and 5,993,137. Neither apparatus includes a hinge point at the base and both interfere with the hosting apparatus. Consequently, both cranes require removal and disassembly between uses. Green teaches a storable crane in U.S. Pat. No. 6,640,908 that shares the concurrent hinge and pivoting point features of the present invention, however, the Green hoist does not teach an insert adapter. By contrast, the '908 patent teaches invasive installation of a crane and box enclosure that is intended to replace the rear bumper of a vehicle.

Kruse teaches a crane in U.S. Pat. No. 6,007,289 that mounts into a receiver hitch and uses a jig to stabilize and increase the lifting capability of the hoist. The '289 patent teaches a design with a low hinge-point that is simple and advantageous in terms of cost. Owing to a high rotational pivoting point, the Kruse lift relies on a removable hoist assembly that is adaptively coupled to the pivoting boom. The hoist assembly must be partially disassembled to enter a folded state and reassembled when returned to an operative state. The stanchion and jig share a common folding point that forces the jig to extend beyond the dimensions of the hoist and the side dimensions of smaller vehicles. The separate location of pivot and hinge points forces the Kruse hoist to fold into a retracted state that can interfere with tailgate and hatchback operation.

Williams teaches a portable mobility chair crane in U.S. Pat. No. 6,830,423 that engages a vehicle receiver adapter. The crane is equipped with a recoverably installed winch attachment. Robinette teaches a low-pivot-point lift in U.S. Pat. No. 5,211,526 that does not have a hinge point. Griffith teaches recoverable installation of a hitch hoist that is suitable for heavier objects in Canadian Patent 2,108,107. Owing to the absence of a low hinge point, the Williams, Robinette, and Griffith hoists must be assembled, mounted, disassembled, and removed between uses.

Davis teaches a multi-purpose hoist in U.S. Pat. No. 5,749,697 with top and bottom components mate together during use. The components require subsequent disassembly for transportation and storage. Likewise Barger teaches a portable crane in U.S. patent application Ser. No. 10/657,029 that is adaptable to shop work benches, vehicles, and other stable structures. The Barger hoist does not easily fold into a stowed state and it requires complete assembly before each use and complete disassembly and removal after each use. Neither hoist teaches a hinge at the base to allow folding.

Amato teaches a swingable boom-type portable crane in U.S. Pat. No. 4,881,864 that engages the receiver hitch of a vehicle. A foot on the lower end of the sanction is retractable to allow the hitch to transport a load in tow. The non-collapsible sanction is fully pivotable, however, it does not include a low hinge point. Consequently, the lift requires disassembly between uses.

A hitch mounted lift that uses a single pivoting point to hoist large sized loads is taught by McVaugh in U.S. Pat. No. 6,042,328. The '328 patent is stowable along the upper rim of a truck bed. Compton teaches a collapsible hoist in U.S. Pat. No. 6,152,675 that has a sufficiently high center mast to elevate hunting game; the hoist is assembled, installed, and subsequently removed between uses. A collapsible hoist taught by Perkins in U.S. Pat. No. 6,578,722 also engages a vehicle receiver hitch and has a telescoping mast that is able to achieve a sufficient height to raise tall objects. Phillip and Angel teach similar game hoists in U.S. Pat. Nos. 6,705,821 and 7,201,552. Like the '675 patent, the '328, '522, '722 and '821 patents teach cranes that do not pivot.

### BRIEF SUMMARY OF THE INVENTION

The principal novelty of the present invention over prior art is the combination of a hinge coupled pivot assembly and an insert adapter at the base of a lifting apparatus. This invention relies on the foregoing to teach a recoverable crane that unfolds into an operable state in a single motion and folds into a stowed state that minimally interferes with the hosting apparatus. Placement of the pivoting point at the lower hinging point further provides a means to optionally couple linear actuators between the pivoting mast and lifting arm. Independent placement of the optional floor jig enables the lift to fold without extending beyond the sides of the hosting apparatus. The embodiments taught herein are scalable, accessorizable, and well suited for any lifting purpose.

### DESCRIPTION OF THE DRAWINGS

Further features, advantages, and benefits of this invention, as well as the structure and operation of various embodiments thereof, are described in detail below with reference to the accompanying drawings. In the drawings, like reference numbers generally indicate identical, functionally similar, and/or structurally similar elements. The drawing in which an element first appears is indicated by the leftmost digits in the corresponding reference number. The drawings disclosed herein are illustrative of preferred and sample embodiments of the disclosed invention and are not intended to limit the spirit or scope thereof.

FIG. 1 shows a preferred embodiment of the present invention that employs electric linear actuators to induce vertical movement.

FIG. 2 shows the individual components of a preferred embodiment of the present invention.

FIG. 3 shows a folded embodiment of the preferred invention and highlights optional embodiments that can be used to lock the invention into open and closed states.

FIG. 4 shows various components of a preferred embodiment of the present invention that employs a hand-pumped hydraulic jack to induce vertical movement.

FIG. 5 shows how a latch assembly can be used to lock moving components of the present invention as well as various attachments that can function with the present invention.

FIG. 6 shows various motorized attachments that can be used to induce movement throughout an embodiment of the hinge and pivotal assembly.

FIG. 7 shows an embodiment of a dimensionally adjustable insert that can be used to tightly engage the present invention to a receiver adapter.

FIG. 8 shows various insert adapter embodiments that can be used to mechanically couple the present invention to a receiver adapter.

FIG. 9 shows an embodiment of the present invention that is mechanically coupled to a bolt-on receiver adapter; the embodiment employs a hand-jack style linear actuator vehicle to lift a personal mobility vehicle.

FIG. 10 shows a vehicle side mounted embodiment of the present invention lifting a powered personal mobility device into a minivan.

FIG. 11 illustrates a method to combine a receiver hitch tray and dual receiver hitch adapter with an embodiment of the present invention to transport a personal mobility device on a vehicle that has limited storage space.

FIG. 12 shows a remote controlled embodiment of the present invention that is being used to lift a personal mobility device.

FIG. 13 illustrates a method to use a preferred embodiment of the present invention to lift a portable cart into a vehicle.

FIG. 14 illustrates a method to use a preferred embodiment of the present invention to transfer an internal combustion engine into a vehicle.

FIG. 15 illustrates a method to use a preferred embodiment of the present invention to lift a pallet and cargo onto a truck.

FIG. 16 illustrates a method to use a preferred embodiment of the present invention to lift an all terrain vehicle onto a truck.

FIG. 17 shows a table mounted embodiment of the present invention.

### DETAILED DESCRIPTION OF PREFERRED EMBODIMENTS

The present invention is a retractable lift optimally engaged to a receiver adapter and capable of folding into retracted and operational states. The term “receiver adapter” refers herein to a device that is sized and shaped to receive and mechanically couple with the present invention. The term “insert adapter” refers herein to a device that is sized and shaped to couple the present invention to a receiver adapter.

The term “vehicle receiver adapter” refers herein to a receiver adapter device on a vehicle that is sized and shaped to receive and mechanically couple with the present invention; a common example thereof is a receiver hitch. The present invention is intended primarily for attachment to a vehicle; however, the present invention is not limited to vehicle use.

The term “linear actuators” is used herein to describe components that cause linear mechanical movement. This may include but is not limited to hydraulic, pneumatic, electric, and mechanical linear actuators.

The term “locks” refers herein to latches, pins, hooks, clamps, links, and other structures that are releasably engaged to control movement throughout the present invention.

Exemplary embodiments use mechanically powered hydraulic, electric, or pneumatic actuators to induce load and hoist movement. The term “mechanically powered” is used herein to specify powered mechanical methods to induce movement such as hydraulic, electric, pneumatic, magnetic, mechanical leverage, and tension as well as future methods that become available to induce movement. By definition herein, the term includes electric motors.

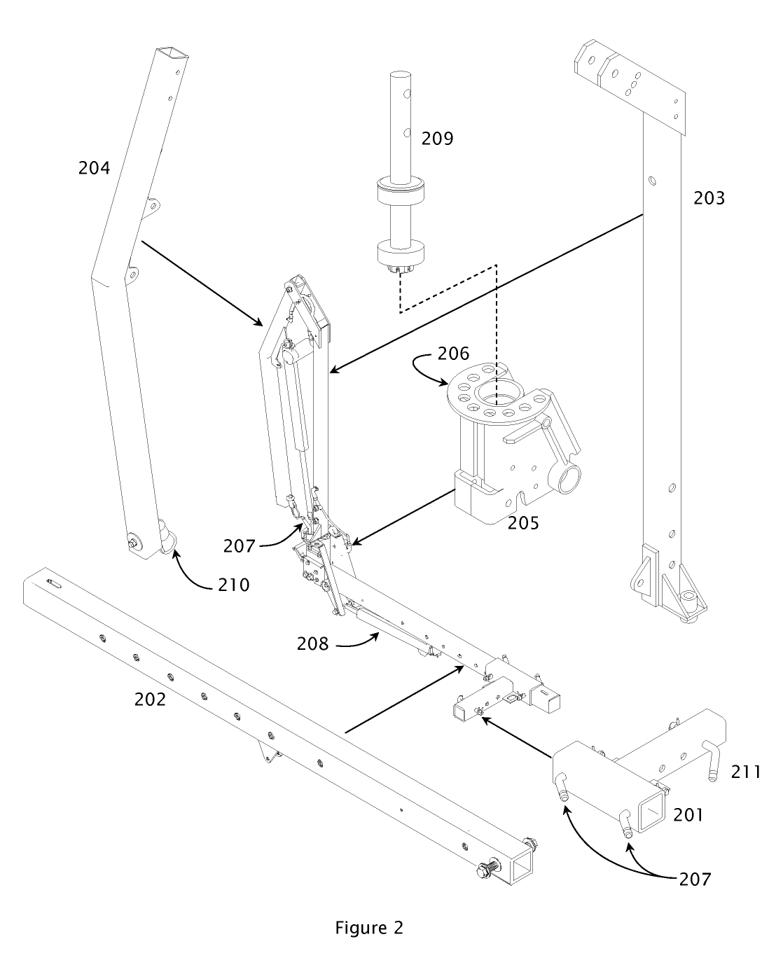

Principal components of preferred embodiments are shown in FIG. 2 and include an insert adapter 201 that engages a receiver adapter or vehicle receiver adapter, a base structure 202 that is mechanically coupled to the insert adapter 201, a mechanically coupled pivoting stanchion 203 and lifting arm 204, and a hinge coupled pivot assembly 205.

The stanchion 203 preferably connects to an axle and bearing assembly 209 in the hinged coupled pivot module 205. Bearingless configurations may be used for embodiments that are intended for light duty applications. In consideration of design trade-offs, larger diameter pivoting assemblies 205 can be used to reduce the overall height of the hoist or to accommodate heavier loads. Other hinge coupled pivoting embodiments may be used without deviating from this invention.

The jointly housed hinge and pivot assembly 205 allows the invention to accept linear actuators while remaining compact. Proper placement of the hinging and pivoting points in this component and throughout this invention are needed to enable the invention to fold into a compact state that does not interfere with or extend beyond the sides the host vehicle.

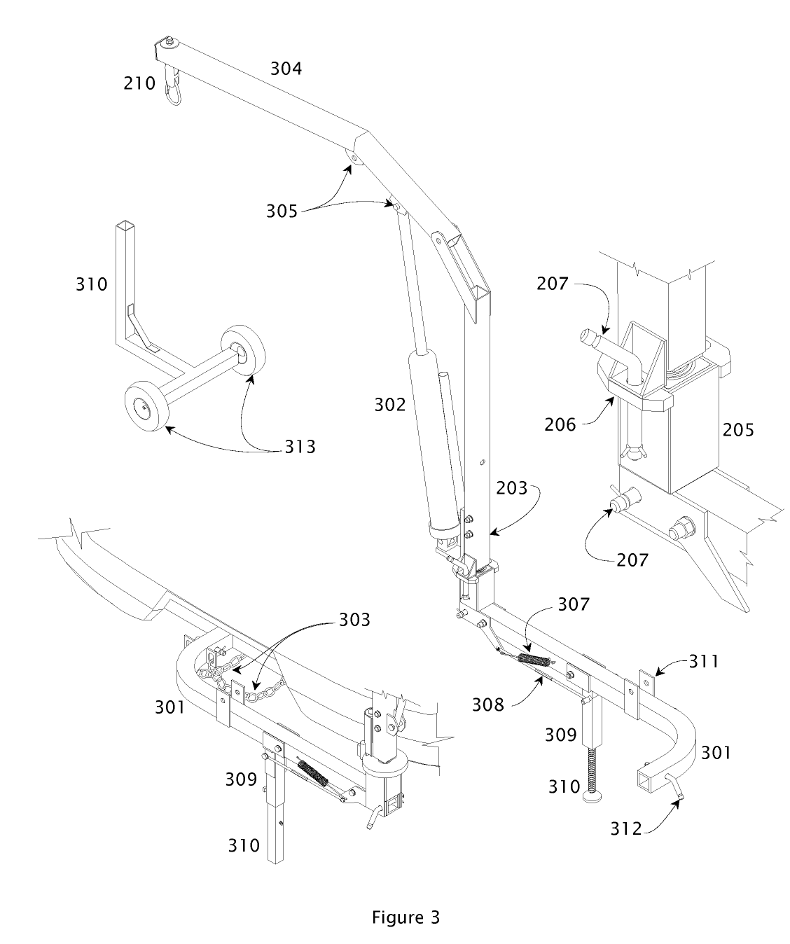

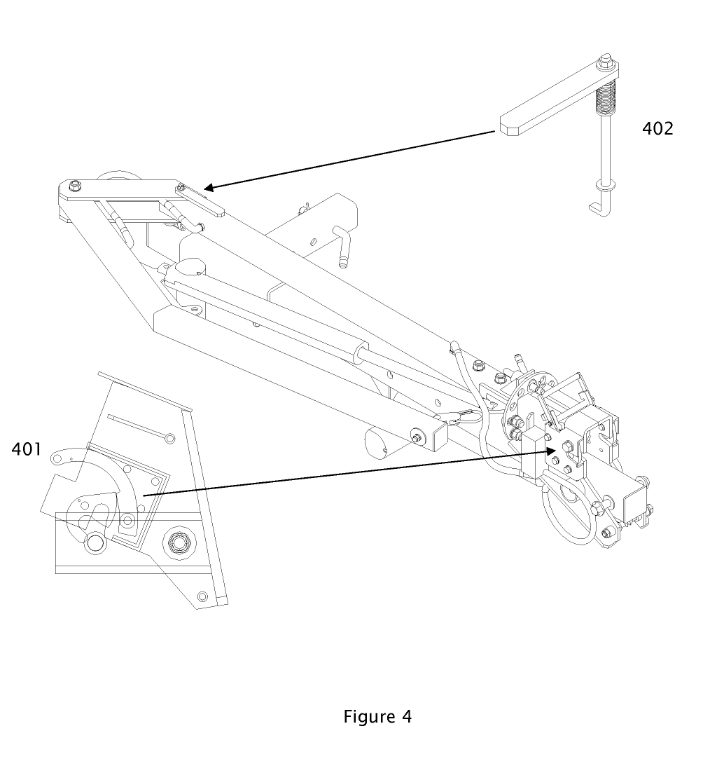

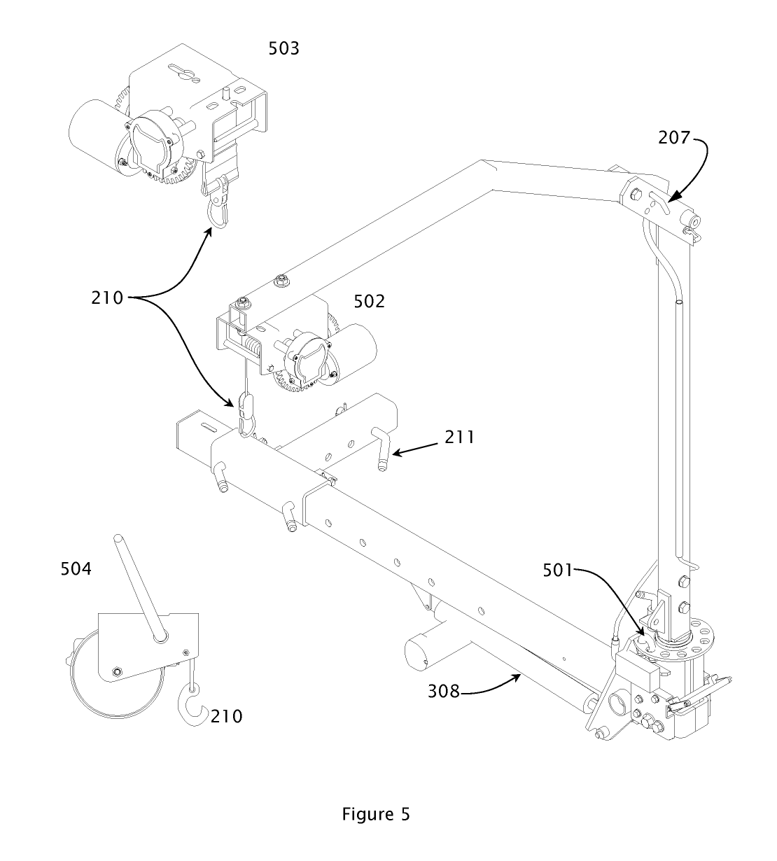

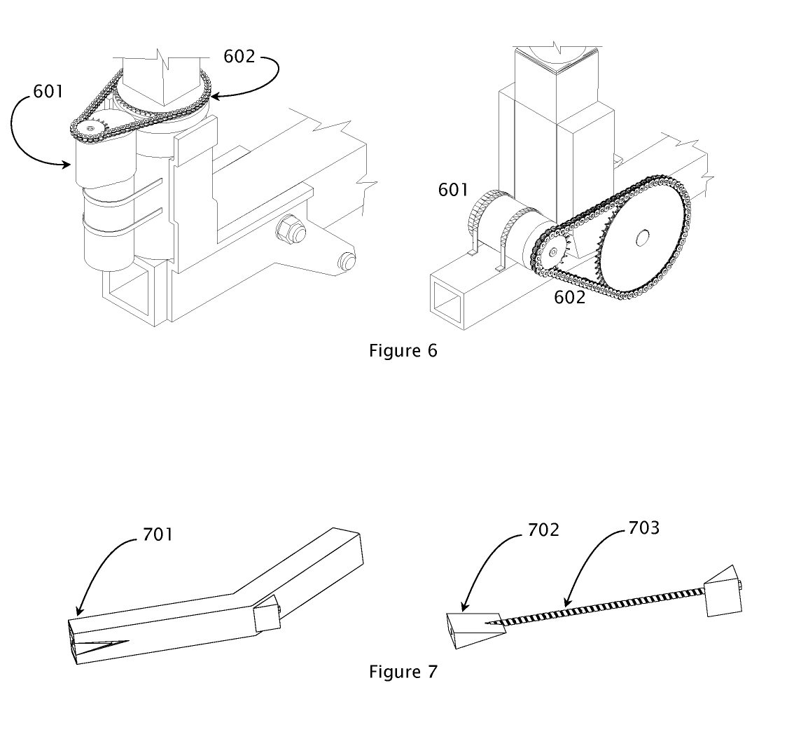

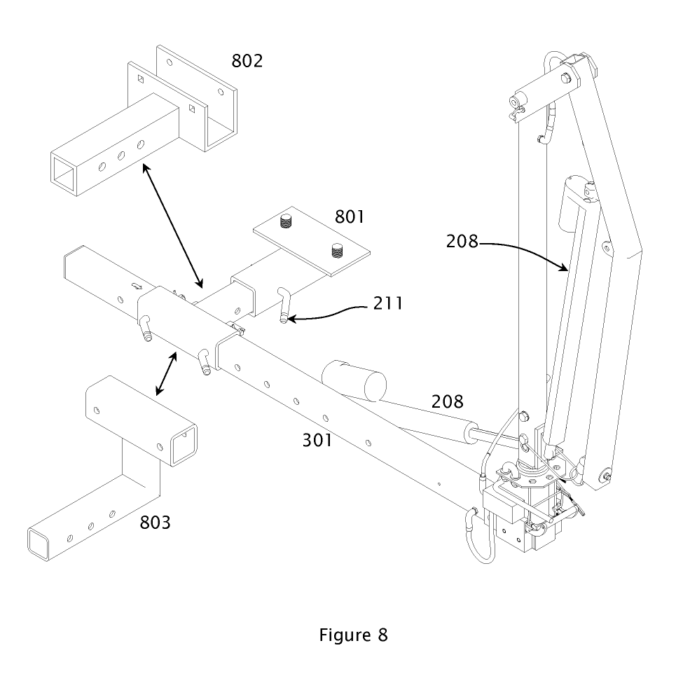

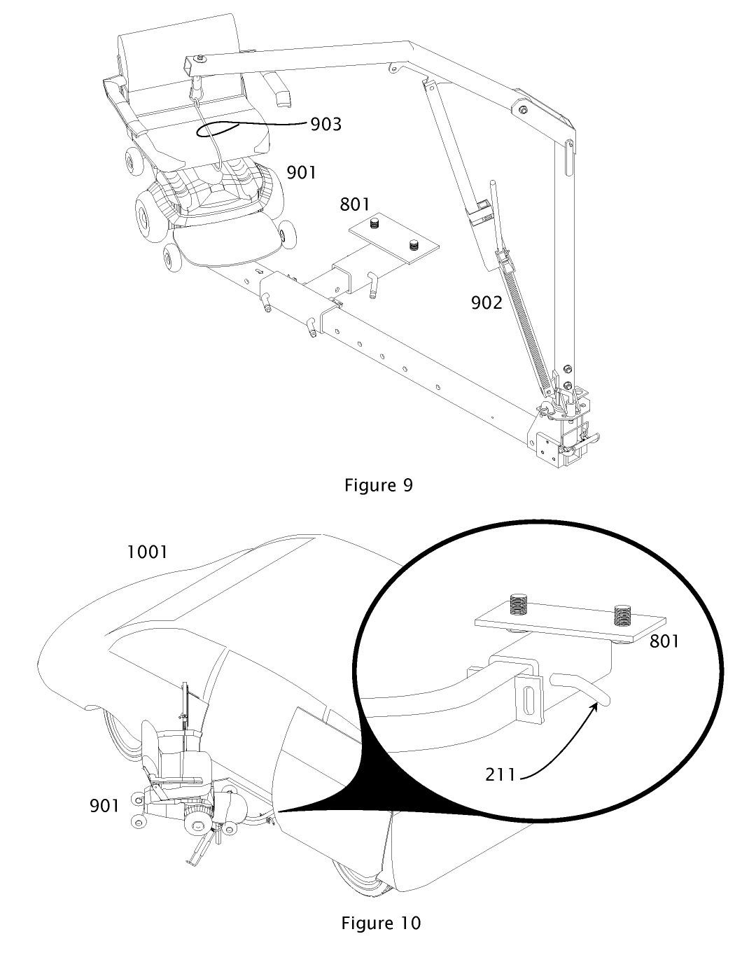

The embodiment in FIG. 2 shows two mechanically coupled components that comprise the insert adapter 205 and base support structure 202 assembly. It is possible to employ various welded assemblies or to form both components from a single bent piece 301 as shown in FIG. 3 without deviating from this invention.

Embodiments of this invention may be held in folded and unfolded states by any plurality of pins 207, clevis and pin assemblies 311, quick-release latches 401, release handle assemblies 402, or any other means.

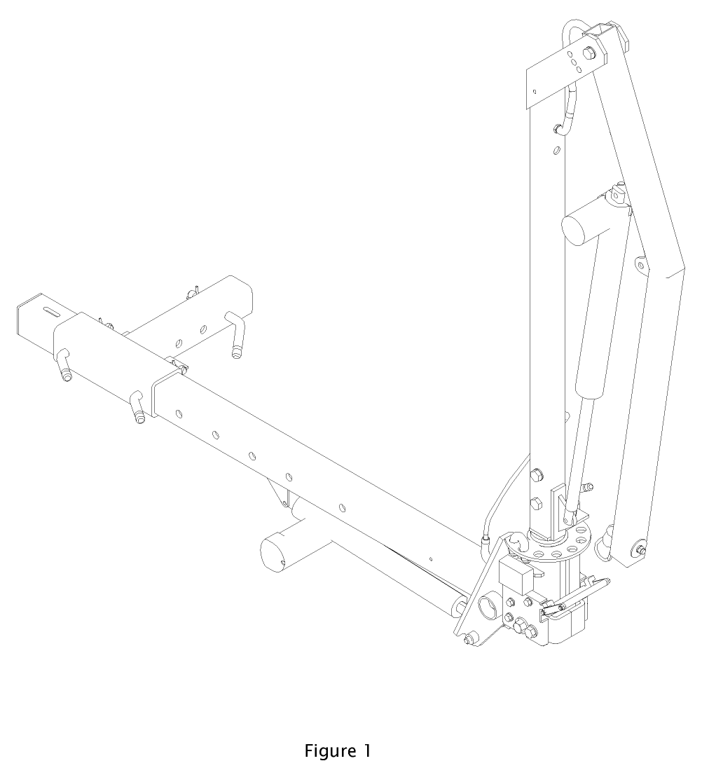

Preferred embodiments of the present invention include components that control pivotal rotation of the stanchion and lifting arm. Stop plates 206 of the types shown in FIGS. 1 and 2 can be combined with U-Bolts 501, retaining pins 207, and stand-alone bolts to restrict pivotal rotation. More robust embodiments may employ disc and hand-brake assemblies or notched cylinders to control pivotal rotation.

Springs 307 may optionally provide assistance in some embodiments as the apparatus is unfolded. Other embodiments alternatively use compressed gas springs, linear actuators 208, hydraulic or pneumatic cylinders, mechanic actuators, electric motors 601, chain drives 602, coil-wound springs, or any other mechanical means in place of the springs 307 to help fold and unfold the apparatus.

The hydraulic long ram jack 302 shown in the exemplary embodiment is well suited for heavy loads and for vehicles without electrical connections near the receiver adapter. The size and capacity rating of the hook 210 should be adjusted to satisfy the intended loads of the hoist. To further accommodate heavier loads, the lifting arm 304 should include multiple clevis points 305 that improve leverage for the linear actuator 302. Gussets and other structures and geometries are preferably used to enhance the strength of the lifting arm as warranted by individual intended applications.

Embodiments that are intended for heavy use may benefit from a single mechanical drive and a turnbuckle 308 or other linkage to cause a supporting jig 309 to extend downward as the stanchion 203 is unfolded upward. Alternative embodiments provide independent folding operation of the jig 309 relative to the stanchion 203.

The supporting jig 309 preferably includes an ancillary segment 310 that uses any means to extend or retract to accommodate changes in distance between the lifting apparatus and the ground or other supporting surface. The ancillary segment 310 is preferably used to level the base support structure 202. The supporting jig 309 is preferably missing or left in a retracted state that does not come into contact with the surface below when sufficiently light loads are lifted by this invention.

The ancillary jig segment 310 may include a plurality of wheels 313 to enable this invention to carry a load in tow with a host vehicle preferably over short distances. Some embodiments may include a bend and a horizontal extension in 310 to balance the load. In preferred embodiments a plurality of mounting plates are welded to the supporting jig 309. In the preferred embodiments the mounting plates are pivotally affixed to the base support structure 202 to enable the jig assembly to fold and unfold. The supporting jig 309 and ancillary segment 310 may not be present in some embodiments and particularly those that are intended for light loads.

An insert adapter that is capable of dimensional adjustment 701 is preferably used to tightly secure this invention to the receiver adapter. An exemplary embodiment uses a wedge 702 and a threaded bolt 703 to tightly secure the engagement point 701 to the receiver hitch. Preferred vehicle mounted embodiments jointly couple the adaptive insert 701 to the vehicle receiver adapter with retaining pins 207, 211 and a plurality of safety chains 303. The vehicle insert retaining pin 211 is preferably tightly fit into the vehicle. Preferred embodiments employ quick-latch components to engage the safety chains 303.

The present invention is preferably accessorizable and intended to benefit from any combination of mechanical and human powered means to induce movement including but not limited to springs 307, coils, cables, cable winches 502, strap winches 503, hand-powered winches 504, mechanical jacks 902, coil springs 307, hydraulic jacks 302, pneumatic or electric 208 actuators, chain hoists, ropes, and straps to induce movement or to couple this invention to a load. Other means such as hooks 210, grasps, tongs, custom connectors 903 and the like can be adaptively used to couple a load to this invention.

### Preferred Methods

It is important to use this invention on a level surface to minimize the threat of damage to the hoist, host vehicle, or payload and further to impede the threat injury to the hoist operator. If this invention is used on an uneven surface, a preferred method to level the hoist employs a level indicator and an extending jig 310. If a load must be lifted from an uneven or un-level surface, a preferred method to prevent damage or personal injury is to secure the rotating pivot with a notched mast collar or a retaining pin 207 and stopping plate 206 assembly.

Exemplary Uses of Preferred Embodiments

This application may be used to lift hand operated and powered wheel chairs into vehicles. For this application it may be important to eliminate or mitigate the need for human involvement during load transfer. Accordingly, some embodiments may rely on remote control 1201 of linear actuators 208 or motor 601 and chain drives 602 to induce movement throughout the hoist.

Adaptive embodiments of this invention may engage the side of a vehicle 1001 to load a personal mobility device 901. Other adaptive embodiments may be placed throughout a vehicle as needed for various applications and to clear existing components of the host vehicle. Doing so may require adaptive vehicle inserts 801 capable of receiving embodiments of the present invention and adjusting the position thereof. For example 801 may be needed to position a vehicle insert to the side of a van as illustrated in FIG. 10.

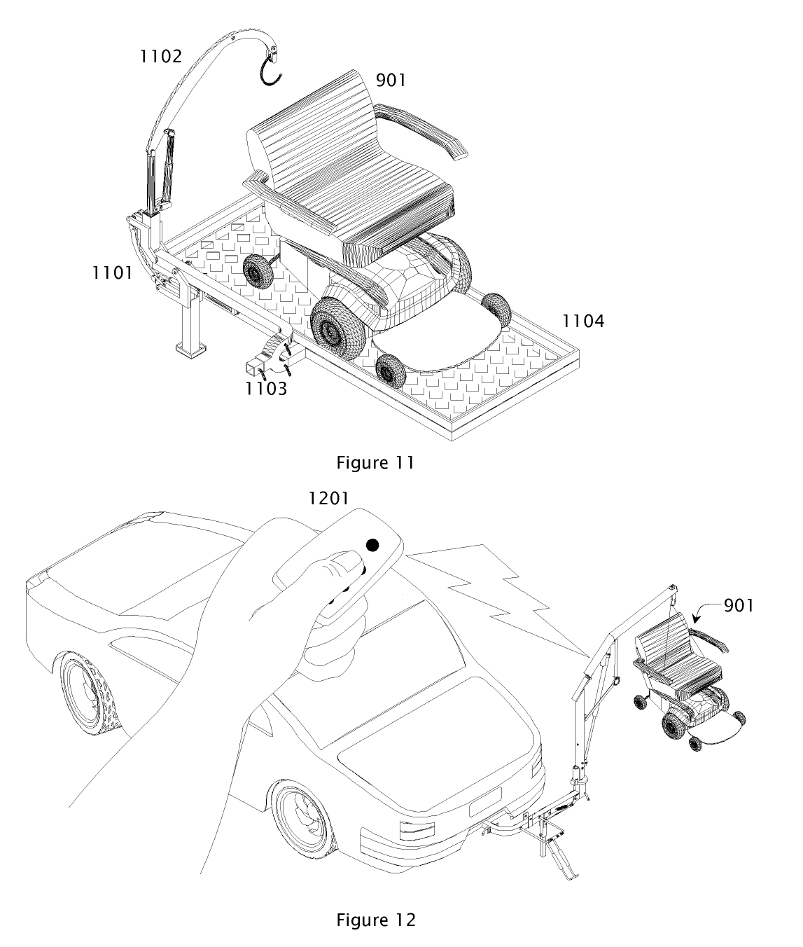

An alternative embodiment that uses hydraulic actuators 803 to induce movement throughout the hoist is shown in FIG. 11. Unlike the previously illustrated embodiments, 1101 and 1102 are not fabricated from conventional square tubing. When cost becomes important, select embodiments of the present invention may rely on mechanical actuators 902 to induce movement.

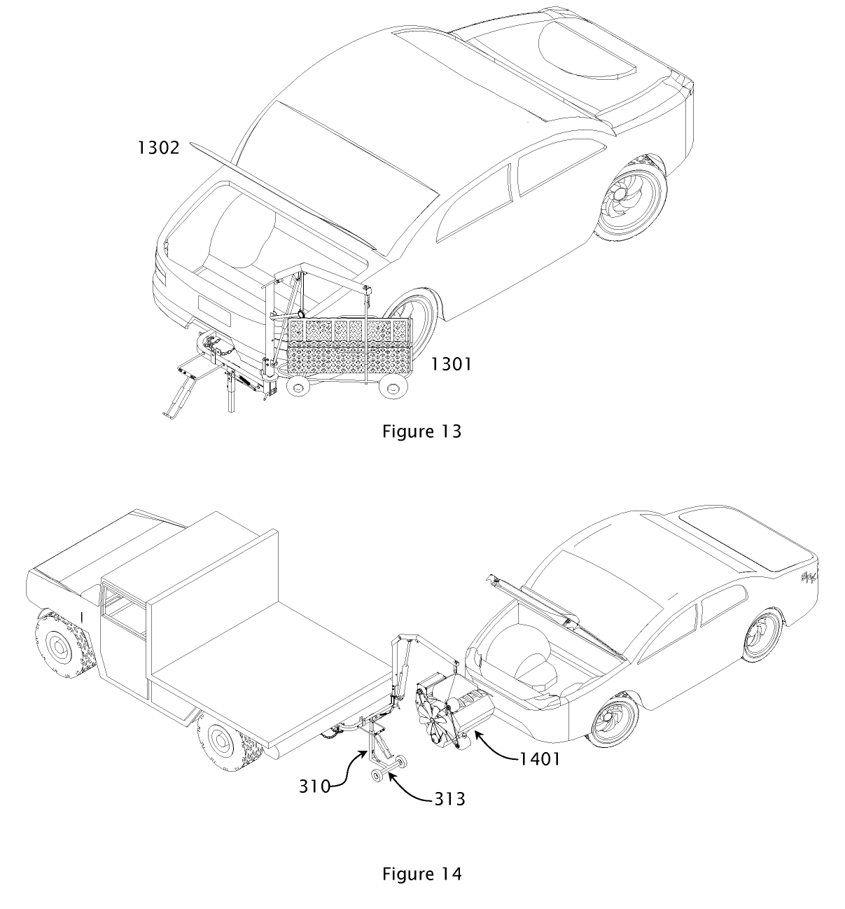

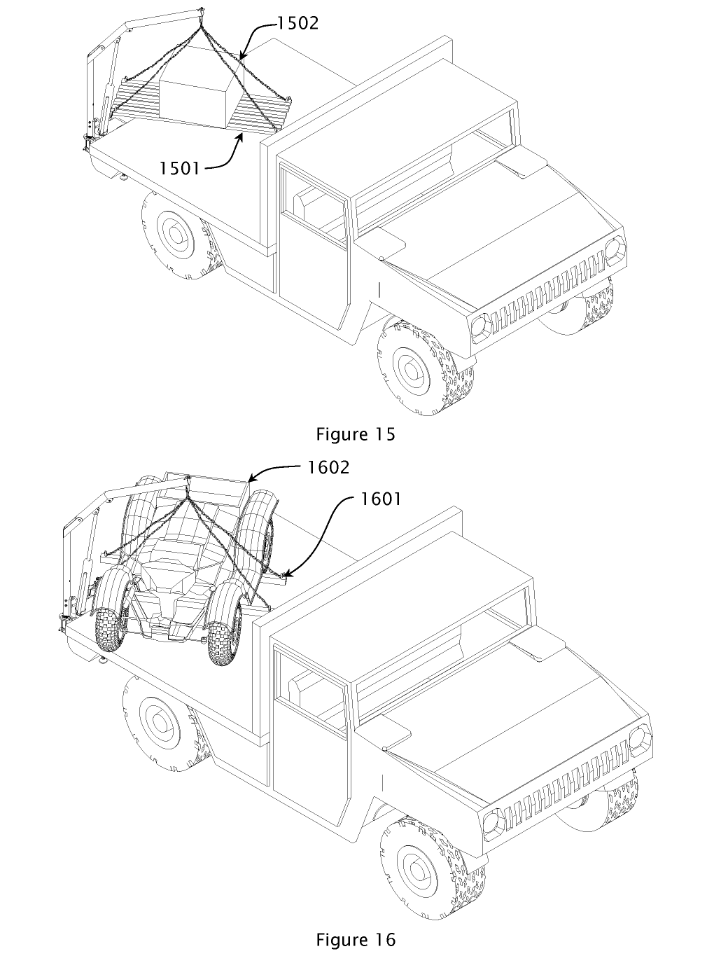

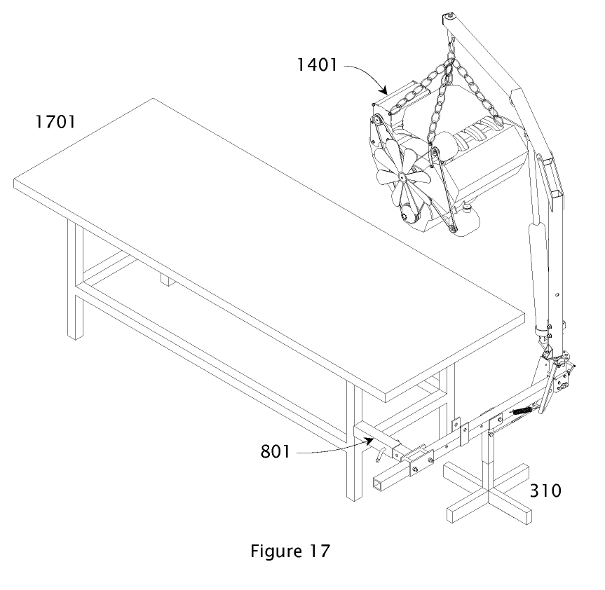

This invention is useful for groceries, portable shopping carts, wheel-chairs, and heavier items such as logs, motorcycles, engines, lawn tractors, garbage receptacles, and pallets. FIG. 13 shows a portable cart 1301 that is being lifted into the trunk 1302 of a vehicle by an embodiment of this invention. If a host vehicle has limited storage space, it may be useful to combine this invention with a dual receiver hitch 1103 and a receiver hitch tray 1104.

This invention can be scaled to accommodate any load of any size or weight that is safe to engage onto or into the host vehicle. FIG. 14 shows how this invention can be used to transfer an engine 1401 from one vehicle to another. A preferred embodiment for moving large objects in tow employs a bent jig 310 and a plurality of wheels 313 to stabilize the hoist and load while it is in tow. Among the numerous embodiments and methods of use, this invention can be used to move items from one vehicle to another or from a vehicle to a loading dock. Various adaptations of the hoist can be used to lift larger objects like pallets 1501 of cargo 1502. It is best to use a pallet or other adapter 1601 when lifting bulky items such as lawn mowers, small watercraft, motorcycles, or ATVs 1602 onto a vehicle.

While a principal motivation of this invention is to enable a vehicle to lift items from the ground, the invention is also able to lift smaller items up and out of the vehicle to an elevation that makes it easier for a person to retrieve them. The invention is also useful if attached to objects other than vehicles such as tables 1701, shop benches, portable carts and other structures.

It is understood that the above embodiments and applications are merely illustrative of the possible specific applications which may represent principles of the present invention. Other arrangements may readily be devised in accordance with the principals herein by those skilled in the art without departing from the scope and spirit of this invention. For example electric switches, computer or microprocessor control, electronic control, other methods, and preferably wireless control may be used to effect movement throughout select embodiments of this invention. Likewise alternative methods to affix the hoist embodiments described herein to a vehicle are also possible.

What is claimed is:

1. A folding portable lifting apparatus that comprises in combination:
a. an insert adapter comprising at least one end that is dimensionally configured to engage a receiver adapter,
b. a mechanical means to recoverably install said insert adapter into said receiver adapter,
c. a base structure mechanically coupled to said insert adapter,
d. a pivot assembly hinge coupled to said horizontal base structure,
e. a stanchion assembly mechanically coupled to the pivoting point of said pivot assembly,
f. a lifting arm hinge coupled to said stanchion assembly,
g. a mechanical means to couple said lifting arm to a load,
h. a mechanical means to raise and lower said load.

2. A portable lifting apparatus of claim 1 that further comprises a mechanical means to fold said pivot assembly relative to the hinge coupling point of said pivot assembly.

3. A portable lifting apparatus of claim 1 that further comprises a mechanical means to fold said lifting arm relative to the hinge coupling point of said lifting arm.

4. A portable lifting apparatus of claim 1 that further comprises a mechanical means to rotate a load relative to said pivoting point of said pivot assembly.

5. A portable lifting apparatus of claim 1 that further comprises a mechanical means to lock said lifting arm relative to said hinge coupling point of said lifting arm into various states of operation.

6. A portable lifting apparatus of claim 1 that further comprises a mechanical means to lock said pivot assembly relative to said hinge coupling point of said pivot assembly into various states of operation.

7. A portable lifting apparatus of claim 1 that further comprises a mechanical means to lock rotation relative to said pivoting point of said pivot assembly.

8. A portable lifting apparatus of claim 1 that further comprises a floor jig mechanically coupled to said lifting apparatus.

9. A portable lifting apparatus of claim 1 that further comprises a plurality of optionally removable components to minimize assembly and disassembly requirements between uses.

10. A portable lifting apparatus of claim 1 that further comprises a base structure and insert adapter that are formed from a single piece of material.

11. An insert adapter fitted to a receiver adapter that comprises a mechanical means to dimensionally adjust until said insert adapter tightly engages said receiver adapter and that further comprises in combination:
a. a plurality of structural gaps on the end of said insert adapter that engages said receiver adapter,
b. a mechanical means to engage and tighten a plurality of wedge shaped components into said structural gaps until said engagement induces sufficient expansion thereof to dimensionally match said insert adapter to said receiver adapter.
